(19) United States
(12) Patent Application Publication
(10) Pub. No.: US 2004/0115460 A1
(43) Pub. Date: Jun. 17, 2004

(54) Modifield wood product and process for the preparation thereof

(76) Inventors: Grigory Torgovnikov, Creswick (AU); Peter Vinden, Creswick (AU)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/472,316

(22) PCT Filed: Mar. 18, 2002
(86) PCT No.: PCT/AU02/00315

(30) Foreign Application Priority Data
Mar. 21, 2001 (AU) PR 3882

(51) Int. Cl. B27D 1/00

(52) U.S. Cl. 428/541

(57) ABSTRACT

A process for the preparation of a modified wood product, the process comprising: modifying moist wood by subjecting the wood to microwave radiation having a microwave energy of from 100 to 4000 joules/cm3 and a frequency (f) of from 0.1 to 10 GHz for a period of from 0.1 to 100 seconds to form a plurality of cavities disposed in radial-longitudinal planes of the wood, at least some of the cavities being interconnected by channels in the radial, tangential and/or longitudinal directions of the wood, drying the modified wood; impregnating the modified wood with an adhesive component; and applying pressure to the impregnated wood to at least partially close the cavities and channels formed during the modification step and to adhere wood fibres with the adhesive component.

The present invention relates to a modified wood product and a process for the preparation thereof. More particularly, the invention relates to a modified wood product formed from wood which has been subjected to microwave treatment to produce a number of cavities in the radial-longitudinal planes of the wood. At least some of the cavities are interconnected by channels extending between the cavities in radial, tangential and/or longitudinal directions. The cavities are filled by impregnation with an adhesive component and subsequently at least partially closed under pressure to form the wood product.

Wood-based materials are known and are widely used in, for example, the building industry. These wood-based materials include as an example plywood and laminated veneer lumber (LVL). The latter of these, however has several disadvantages including a lack of natural appearance, non-uniform properties, complicated technology and high cost of veneer production and requirement for raw material quality.

The present invention advantageously provides a modified wood product which may be employed as an alternative to these and other materials, wood-based or otherwise, and which may alleviate some or all of the above disadvantages. The modified wood product advantageously has high strength and good dimensional stability, a natural appearance and structure and may be made using low grade material, such as heartwood of radiata pine or Douglas fir. The process for the production of the modified wood product advantageously requires simple technology compared with that required for LVL, resulting in cheaper production of the product.

According to the present invention there is provided a process for the preparation of a modified wood product, the process comprising: modifying moist wood by subjecting the wood to microwave radiation having a microwave energy of from 100 to 4000 joules/cm3 and a frequency (f) of from 0.1 to 10 GHz for a period of from 0.1 to 100 seconds to form a plurality of cavities disposed in radial-longitudinal planes of the wood, at least some of the cavities, being interconnected by channels in the radial, tangential and/or longitudinal directions of the wood; drying the modified wood; impregnating the modified wood with an adhesive component; and applying pressure to the impregnated wood to at least partially close the cavities and channels formed during the modification step and to adhere wood fibres with the adhesive component.

There is also provided a modified wood product formed by the process described in the immediately preceding paragraph.

According to another aspect of the invention there is provided a modified wood product comprising a plurality of veins disposed in radial-longitudinal planes of the modified wood product, wherein the veins contain an adhesive component which adheres wood fibres of the modified wood product together and are formed by applying pressure to a modified wood which has a plurality of open cavities in radial-longitudinal planes thereof which have been impregnated with the adhesive component and at least some of which are interconnected by channels in the radial, tangential and/or longitudinal directions of the modified wood.

The modification step involving the application of microwaves to the wood expands wood rays in the wood to form cavities either in place of the ray tissue and/or adjacent to the ray tissue in the radial, longitudinal and tangential direction, thus expanding the wood in the area of microwave treatment. The modification also provides rupturing wooden cell pore membranes, walls and also destroying tyloses in the vessels or vessel elements of hardwood species, which form the channels. The channels are created in the radial, tangential and/or longitudinal directions of the wood and interconnect at least some of the cavities. In a preferred embodiment, during the modification step the volume of the wood is increased by up to 15% (based on the dry volume of the wood).

The modified wood, after the application of the microwave, may optionally be dried by any suitable means, including those conventionally available, to bring the moisture content of the wood to a desired level. Preferably, in the drying step the wood is dried by the application of a microwave, by convection or by other means. Similarly, due to the increased permeability of the wood after the microwave treatment, the adhesive component may be impregnated into the wood by any suitable means. For example, in the impregnation step the wood may be impregnated by soaking or by pressure impregnation in a pressure vessel. Still further, the pressure which is applied to the impregnated wood may be applied as desired, but preferably in the pressure application step pressure is applied to the impregnated wood primarily in a tangential direction of the wood.

The adhesive component may include any component which may be impregnated into the modified wood and which may effectively bond the wood fibres of the modified wood together when pressure is applied to the wood. However, in a preferred embodiment, the adhesive component is a resin selected from the group consisting of diphenylmethane diisocyanate, formaldehyde based resins such as phenol formaldehyde, melamine urea formaldehyde etc; fast setting resins or adhesives used in panel product manufacture, for example, glues made from plant or animal material—starch and casein.

Other additives may also be included in the adhesive component, or may be added separately to the adhesive component to improve the technological attributes of the final product. For example, fire retardants, fungicides and insecticides, water repellents or chemical modification agents that improve the stability of the wood may be added. Colouring agents may also be added to the adhesive component to alter the physical appearance of the final product. As such, it may be possible to replicate one species of tree using the wood of another by the inclusion of a colouring agent in the adhesive component. For example, a modified radiata pine may be impregnated with a darker adhesive component such that the appearance of the final product after pressing and curing is similar to oak.

Non-resin binding may also be achieved by heating, the use of plasma, partial pulping or chemical modification, for example using acetylation or surface active agents.

The pressure which is applied during the pressure application step, which is as mentioned above preferably applied primarily in a tangential direction of the wood, may be applied at any suitable pressure for a predetermined time to achieve a desired result provided that the at least partially closed, and/or closed, cavities and channels interconnecting at least some of those cavities are formed. Pressure may be applied to return the wood to its original dimensions, or alternatively less pressure may be applied so that the final modified wood product has greater dimensions than the original wood sample or greater pressure may be applied such that the formed modified wood product has lesser dimensions than the original wood sample. It will be understood that the amount of pressure applied will also effect the strength characteristics of the final modified wood product. It will also be understood that the impregnation of the wood with different adhesive components and different specific values (percentages) of the adhesive component in the modified wood product will also provide for differing physical and mechanical properties of the modified wood product. Preferably, the modified wood product contains from about 1 to 40% of adhesive component based on the dry weight of the wood. Still further, the application of pressure to the impregnated wood may be performed so as to provide different shapes to the modified wood product. For example, the impregnated wood may be subjected to a pressure to form a modified wood product with rectangular, round, oval or other cross section. Also during the pressing process various pressures can be applied to different parts of the material to produce products of varied shape.

It should also be understood that the microwave modification of the wood structure as described herein, its impregnation with adhesive and subsequent bending, such as using a mould, and curing of the adhesive may provide a rapid method for the production of bent or curved wood products and components for furniture and joinery products.

It has been found that modified wood product produced from microwave modified ash (eucalyptus regnans) which has been impregnated with 6-14% (based on dry weight) diphenylmethane diisocyanate (MDI) resin and subjected to a pressure to produce a cross sectional size equivalent to the initial natural timber has a bending strength in the radial direction which is 1.5-2.1 times and in the tangential direction 1.3-1.6 times higher than that of the natural wood. Adhesive component in the modified wood product is disposed mainly in radial-longitudinal planes thereof and, as such, the bending strength of the modified wood product in radial directions is higher compared with those in tangential directions. The hardness of the modified wood product (radial and tangential surfaces) is generally about 1.4-2.3 times greater than that of the natural wood.

Table 1 below is provided to show a comparison of structural lumbers (based on softwoods) with a modified wood product according to the invention.

TABLE 1

| | | | GLU- | Modified |
|---|---|---|---|---|
| | | Stress-graded | LAM | Wood Product |
| | LVL | lumber (T30) | L-40 | (estimated) |
| Allowable | | | | |
| stresses (MPa): | | | | |
| bending | 18 | 11 | 14 | 16-20 |
| shear | 1.7 | 1.0 | 1.2 | 1.4-1.7 |
| MOE | 10,000 | 7,000 | 8,400 | 9,000-10,000 |
| Practical max | | | | |
| dimns. (mm): | | | | |
| length | unlimited | 6,000 | 30,000 | 6,500 |
| thickness | 75 | 150 | 150 | 200 |
| width | 1200 | 225 | 2000 | 200 |

From the above Table, it can be seen that the modified wood product according to the invention has good strength and practical characteristics compared with other wood based materials.

It will be recognised that the process parameters for the initial microwave modification of the wood, drying of the modified wood, the impregnation of the wood and final pressurization of the wood may be altered depending on, for example, the wood species, initial moisture content of the wood, dimensions of the timber being treated, adhesive component properties and requirements for the final product It will also be recognised that the initial microwave treatment may be applied to the entirety of the wood, or the microwave may be applied to predetermined segments of the wood. The predetermined segments may include outer portions of the wood. That is, the central portion of the wood may remain untreated. Alternatively, the wood may be subjected to a microwave in zones along its longitudinal length such that the final modified wood product includes zones along its longitudinal length of high and low strength.

In an alternative aspect of the invention there is provided a method for the preparation of a low density modified wood product, the process comprising: modifying moist wood by subjecting the wood to microwave radiation having a microwave energy of from 100 to 4000 joules/cm3 and a frequency (f) of from 0.1 to 10 GHz for a period of from 0.1 to 100 seconds to form a plurality of cavities disposed in radial-longitudinal planes of the wood, at least some of the cavities being interconnected by channels in the radial, tangential and/or longitudinal directions of the wood, drying the modified wood; impregnating the modified wood with an adhesive component.

Embodiments of the present invention will now be described with reference to the accompanying drawings in which:

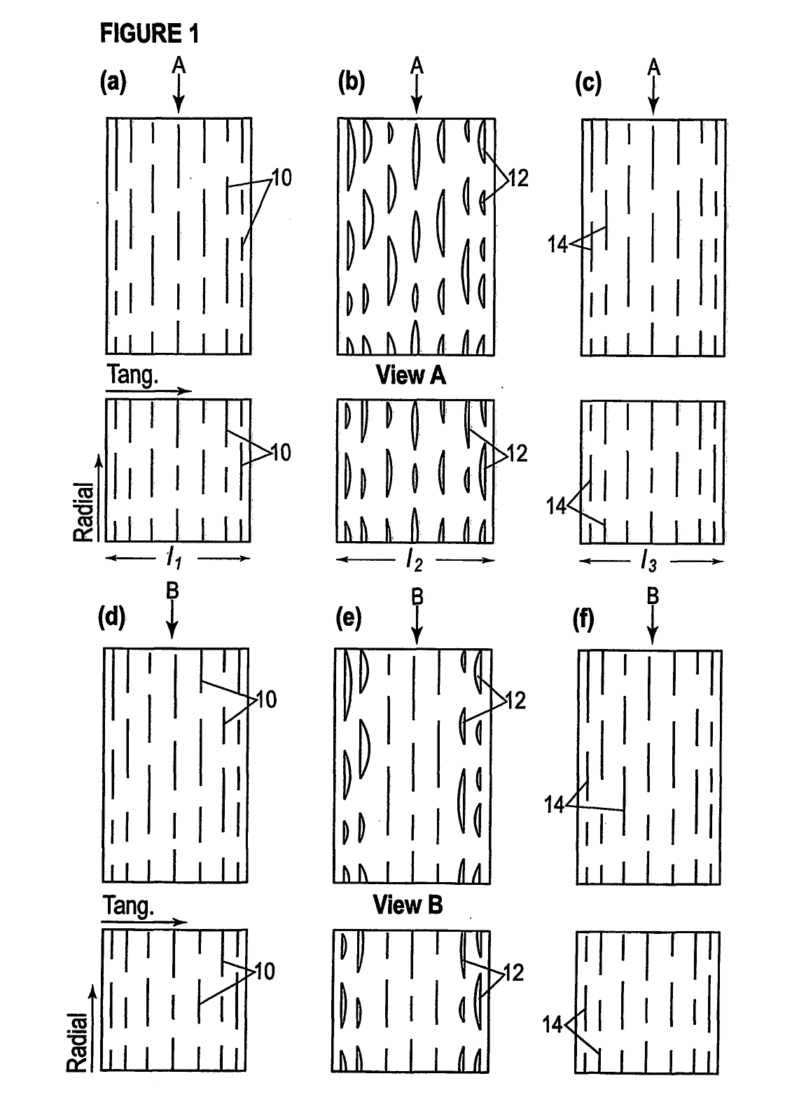

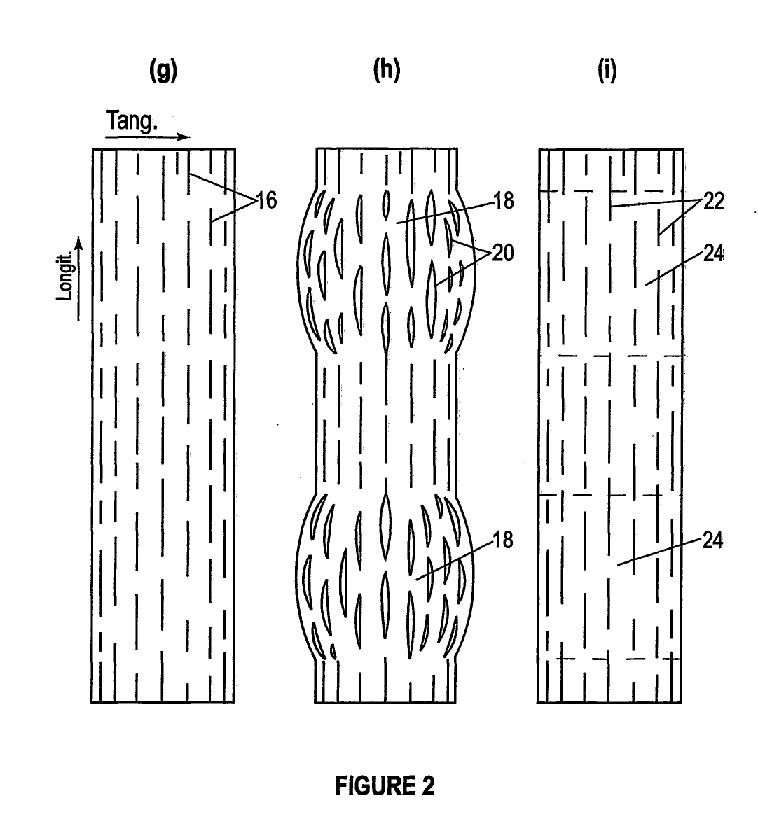

FIGS. 1 and 2 are straight views of a modified wood product according to embodiments of the invention; and

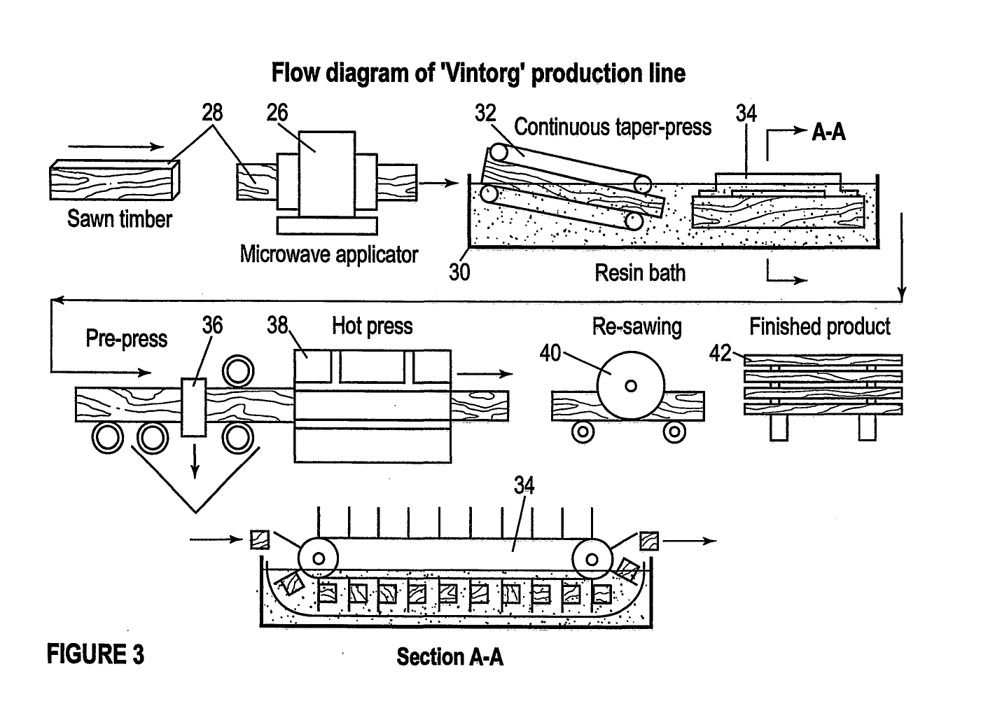

FIG. 3 illustrates a schematic view of a production line for the modified wood product.

Referring to FIG. 1, the samples a), b), c), and d), e), f) have cross sections according to views A and B in the radial and tangential directions. The samples a) and d) are moist natural wood with ray tissue 10. After microwave modification the sample b) has cavities 12 disposed in radial-longitudinal planes which are formed by destruction and extending of wooden rays resulting in increased wood volume up to 15%. The size 12 is larger than size 11. After impregnation the cavities are filled in with an adhesive component, such as a resin. After pressing in the tangential direction a modified wood product (sample c)) with closed cavities 14 is formed. The size 13 is equal to 11 after pressing. Also, depending on the pressing degree tangential size of the wood product can be more or less than 11 of the natural wood sample. The strength properties of the modified wood product sample c) is higher compared with natural wood sample a).

In the sample d) only shell layers are microwave modified such that the sample e) has cavities 12 in surface layers on both sides. After impregnation and pressing, a modified wood product sample f) is formed with better bending strength properties if a load is applied tangentially thereto. The treated surfaces will also be of greater hardness than the untreated wood.

As such, it is possible to make cavities in different zones of timber cross sections to produce modified wood product with defined strength properties. Closed cavities provide the wood with better dimensional stability.

Referring to FIG. 2, sample g) is natural moist wood with rays tissue 16. After microwave modification of zones 18 (sample h)) the wood has cavities 20 in radial-longitudinal planes. After impregnation and pressing, a modified wood product is formed with closed cavities 22 (sample i)) and zones 24 with higher strength properties compared with the natural wood (sample g)).

Referring to FIG. 3, a production line comprises a microwave installation 26 for timber 28 modification, a resin bath 30 for timber soaking with resin, a continuous or static press 32 for pressing material and feeding to the resin, a cross conveyor 34 for timber transporting along the bath, an optional pre-press 36 for removing superfluous resin, a hot press 38 for material gluing, sawing equipment 40 and finish product storage 42.

The invention will now be exemplified with reference to the following example which is provided for exemplification only and should not be construed as limiting on the invention in any way.

### EXAMPLE 1

Initial Data:

| Cross section of sawn timber | 100 × 100 mm |
|---|---|
| (low-grade radiata pine heartwood) | |
| Length | 4-6.5 m |
| Moisture content | 35-40% |
| Moisture content before impregnation | 10-13% |

Sawn timber 28 (FIG. 3) was modified in a microwave installation with treatment parameters: frequency—0.922 GHz, microwave power—42 kW, feeding speed—12 mm/sec. After microwave treatment the timber had a moisture content of 10-12% and did not require special drying. The treated timber had a multitude of cavities disposed in radial-longitudinal planes which were formed by destruction and extending of wooden rays and which provided very high wood permeability. The thickness of the wood material in the tangential direction increased up to 110 mm.

Continuous press 32 removed air from the cavities to facilitate easy impregnation and to feed material to the bath 30 containing resin Rubinate 1840. Cross conveyor 34 moved the modified timber though the bath for 30-90 min to achieve good penetration of the resin in the timber.

After soaking, pre-press 36 removed resin surplus from the timber and hot press 38 pressed the material to a thickness of 100 mm to obtain a modified wood product of the same cross section as the raw timber. The temperature of the hot press was 120-130□C applied over a period of from 85-180 min.

After pressing, the modified wood product had strength properties 1.4-1.9 times higher compared with the natural wood.

The production process for hardwoods is similar to that described above, but if the initial moisture content is 80-100% after microwave treatment the moisture content can be 40-50%. To reduce this content to from 10-13% the wood is preferably dried. It is possible to use the same microwave installation in this case, but it can be more expensive compared with convection drying. For economic reasons, material drying is generally achieved in a convection kiln at an air temperature of from 100-120□C.

Also impregnation of some hardwood species by soaking can take a long time and therefore pressure impregnation is preferably employed.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps or features.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A process for the preparation of a modified wood product, the process comprising:
modifying moist wood by subjecting the wood to microwave radiation having a microwave energy of from 100 to 4000 joules/cm3 and a frequency (f) of from 0.1 to 10 GHz for a period of from 0.1 to 100 seconds to form a plurality of cavities disposed in radial-longitudinal planes of the wood, at least some of the cavities being interconnected by channels in the radial, tangential and/or longitudinal directions of the wood,
drying the modified wood;
impregnating the modified wood with an adhesive component; and
applying pressure to the impregnated wood to at least partially close the cavities and channels formed during the modification step and to adhere wood fibres with the adhesive component.

2. A process according to claim 1, wherein during the modification step said microwave treatment ruptures cell membranes and walls of the wood and wherein, if the wood is a hardwood species, the microwave treatment ruptures tyloses in vessels of the wood.

3. A process according to claim 1, wherein during the modification step the volume of the wood is increased by up to 15% (based on the dry volume of the wood).

4. A process according to claim 1, wherein in the drying step the wood is dried by the application of a microwave, by convection or by other means.

5. A process according to claim 1, wherein in the impregnation step the wood is impregnated by soaking or by pressure impregnation in a pressure vessel.

6. A process according to claim 1, wherein in the pressure application step pressure is applied to the impregnated wood primarily in a tangential direction of the wood.

7. A process according to claim 1, wherein the adhesive component is a resin selected from the group consisting of diphenylmethane diisocyanate, formaldehyde based resins such as phenol formaldehyde and melamine urea formaldehyde; fast setting resins or adhesives glues such as starch and casein.

8. A process according to claim 1, wherein at least one other additives is included in the adhesive component, the additive being selected from fire retardants, fungicides, insecticides, water repellents, chemical modification agents that improve the stability of the wood and colouring agents.

9. A process according to claim 1, wherein the modified wood product contains from about 1 to 40% of adhesive component based on the dry weight of the wood.

10. A process according to claim 1, wherein during the pressure application step various pressures are applied to different parts of the impregnated wood to produce a product having a desired shape.

11. A process according to claim 1, wherein the modification step includes subjecting the entirety of the wood or predetermined segments of the wood to microwave radiation.

12. A process according to claim 11, wherein the predetermined segments include outer portions of the wood.

13. A process according to claim 11, wherein the wood is subjected to microwave radiation in zones along its longitudinal length such that the final modified wood product includes zones having different properties along its longitudinal length.

14. A modified wood product formed by the process of claim 1.

15. A method for the preparation of a low density modified wood product, the process comprising:
modifying moist wood by subjecting the wood to microwave radiation having a microwave energy of from 100 to 4000 joules/cm3 and a frequency (f) of from 0.1 to 10 GHz for a period of from 0.1 to 100 seconds to form a plurality of cavities disposed in radial-longitudinal planes of the wood, at least some of the cavities being interconnected by channels in the radial, tangential and/or longitudinal directions of the wood,
drying the modified wood;
impregnating the modified wood with an adhesive component.

16. A low density modified wood product formed by the process of claim 15.

17. A modified wood product comprising a plurality of veins disposed in radial-longitudinal planes of the modified wood product, wherein the veins contain an adhesive component which adheres wood fibres of the modified wood product together and are formed by applying pressure to a modified wood which has a plurality of open cavities in radial-longitudinal planes thereof which have been impregnated with the adhesive component and at least some of which are interconnected by channels in the radial, tangential and/or longitudinal directions of the modified wood.

18. A wood product according to claim 17, wherein the adhesive component is a resin selected from the group consisting of diphenylmethane diisocyanate, formaldehyde based resins such as phenol formaldehyde and melamine urea formaldehyde; fast setting resins or adhesives glues such as starch and casein.

19. A wood product according to claim 17, which contains from about 1 to 40% of adhesive component based on the dry weight of the wood.
